(19) United States
(12) Patent Application Publication
(10) Pub. No.: US 2016/0069291 A1
(43) Pub. Date: Mar. 10, 2016

(54) HYBRID POWERTRAIN AND METHOD OF OPERATING SAME

(71) Applicant: CATERPILLAR INC., Peoria, IL (US)

(72) Inventors: XINYU GE, PEORIA, IL (US); YONGLI QI, PEORIA, IL (US)

(73) Assignee: CATERPILLAR INC., Peoria, IL (US)

(21) Appl. No.: 14/481,442

(22) Filed: Sep. 9, 2014

(51) Int. Cl. F02D 41/30; F02B 1/14; F02D 41/00; F02B 69/04

(52) U.S. Cl. CPC F02D 41/3035; F02B 69/04; F02B 1/14; F02D 41/0027

(57) ABSTRACT

A method for operating a hybrid powertrain includes effecting a first mixture in a combustion chamber of an internal combustion engine while the internal combustion engine operates at a first predetermined load, the first mixture being lean of stoichiometric and being substantially homogeneous throughout the combustion chamber at a first start of combustion time; effecting a second mixture in the combustion chamber while the internal combustion engine operates at a second predetermined load, the second mixture being lean of stoichiometric and being substantially homogeneous throughout the combustion chamber at a second start of combustion time; and effecting a third mixture in the combustion chamber while the internal combustion engine transitions from the first predetermined load to the second predetermined load, the third mixture including a fuel-rich region being rich of stoichiometric at a third start of combustion time.

### TECHNICAL FIELD

This patent disclosure relates generally to reciprocating internal combustion engines and, more particularly, to internal combustion/electric hybrid powertrain systems and methods of operating the same.

### BACKGROUND

Reciprocating internal combustion (IC) engines are known for converting chemical energy stored in a fuel supply into mechanical shaft power. A fuel-oxidizer mixture is received in a variable volume of an IC engine defined by a piston translating within a cylinder bore. The fuel-oxidizer mixture burns inside the variable volume to convert chemical energy in the mixture into heat. In turn, expansion of the combustion products within the variable volume performs work on the piston, which may be transferred to an output shaft of the IC engine.

Various combinations of IC engines, electrical generators, and electric motors are known for composing electric hybrid powertrains. In a serial hybrid powertrain, shaft power from an IC engine is coupled with an electric generator for producing electrical energy but the shaft power is not directly coupled to a load via a mechanical transmission. Further according to serial electric hybrid designs, work is performed on loads by electric motors receiving power from the electric generator, an energy storage device (e.g., an electric battery), or both. In a parallel hybrid powertrain, shaft power from an IC engine is coupled to both an electric generator and a load via a mechanical transmission, such that work is performed on the load by shaft power from the engine, electrical power from the generator, electrical power from an energy storage device, or combinations thereof.

Homogeneous charge compression ignition (HCCI) engines have been used in electric hybrid powertrains. Similar to spark ignition engines, the fuel-oxidizer mixture in an HCCI engine is substantially homogeneous within the variable volume at the time of ignition or start of combustion (SOC). However, HCCI engines tend to operate with much leaner fuel-oxidizer mixtures than spark ignition engines, which usually operate near stoichiometric fuel-oxidizer mixture strengths, and ignition of the fuel-oxidizer mixture in a pure HCCI cycle is achieved by compression of the mixture without extrinsic ignition sources such as spark plugs or pilot fuel injections.

U.S. Pat. No. 6,907,870 (the '870 patent), entitled “Multiple Operating Mode Engine and Method of Operation,” purports to describe an IC engine capable of operating in, and transitioning between, different operating modes including a premixed charge compression ignition mode, a diesel mode, and/or a spark ignition mode. The '870 patent further describes a homogeneous charge dual fuel transition mode for use in transitioning between operating modes. However, the '870 patent does not offer guidance for transitions between predetermined engine load settings within a particular operating mode. Accordingly, the present disclosure addresses the aforementioned problems and/or other problems in the art.

### SUMMARY

According to an aspect of the disclosure, a hybrid powertrain system comprises an internal combustion engine having a piston configured to reciprocate within a cylindrical bore, the piston and the cylindrical bore at least partly defining a combustion chamber; an electric generator operatively coupled to the internal combustion engine; a fuel injection system in fluid communication with at least one fuel source and the combustion chamber; and a controller operatively coupled to the fuel injection system. The controller is configured to effect a first mixture including a first portion of fuel and a first portion of oxidizer while the internal combustion engine operates at a first predetermined load, the first mixture being lean of stoichiometric and being substantially homogeneous throughout the combustion chamber at a first start of combustion time, effect a second mixture including a second portion of fuel and a second portion of oxidizer while the internal combustion engine operates at a second predetermined load, the second mixture being lean of stoichiometric and being substantially homogeneous throughout the combustion chamber at a second start of combustion time, and effect a third mixture including a third portion of fuel and a third portion of oxidizer while the internal combustion engine transitions from the first predetermined load to the second predetermined load, the third mixture including a fuel-rich region being rich of stoichiometric at a third start of combustion time.

Another aspect of the disclosure provides a method for operating a hybrid powertrain. The hybrid powertrain including an internal combustion engine having a piston configured to reciprocate within a cylindrical bore, the piston and the cylindrical bore at least partly defining a combustion chamber, and a fuel injection system in fluid communication with at least one fuel source and the combustion chamber. The method comprises operating the internal combustion engine at a first predetermined load using a first mixture including a first portion of fuel and a first portion of oxidizer, the first mixture being lean of stoichiometric and being substantially homogeneous throughout the combustion chamber at a first start of combustion time; operating the internal combustion engine at a second predetermined load using a second mixture including a second portion of fuel and a second portion of oxidizer, the second mixture being lean of stoichiometric and being substantially homogeneous throughout the combustion chamber at a second start of combustion time; and transitioning the internal combustion engine from the first predetermined load to the second predetermined load using a third mixture including a third portion of fuel and a third portion of oxidizer, the third mixture including a fuel-rich region being rich of stoichiometric at a third start of combustion time.

According to another aspect of the disclosure, an article of manufacture comprises non-transitory machine-readable instructions encoded thereon for enabling a processor to perform the operations of effecting a first mixture in a combustion chamber of an internal combustion engine while the internal combustion engine operates at a first predetermined load, the first mixture including a first portion of fuel and a first portion of oxidizer, the first mixture being lean of stoichiometric and being substantially homogeneous throughout the combustion chamber at a first start of combustion time; effecting a second mixture in the combustion chamber while the internal combustion engine operates at a second predetermined load, the second mixture including a second portion of fuel and a second portion of oxidizer, the second mixture being lean of stoichiometric and being substantially homogeneous throughout the combustion chamber at a second start of combustion time; and effecting a third mixture in the combustion chamber while the internal combustion engine transitions from the first predetermined load to the second predetermined load, the third mixture including a third portion of fuel and a third portion of oxidizer, the third mixture including a fuel-rich region being rich of stoichiometric at a third start of combustion time.

### BRIEF DESCRIPTION OF THE DRAWINGS

FIG. 1 shows a side view of a machine, according to an aspect of the disclosure.

FIG. 2 shows a schematic view of a hybrid powertrain 102, according to an aspect of the disclosure.

FIG. 3 shows a schematic view of an IC engine, according to an aspect of the disclosure.

FIG. 4 shows a schematic view of an IC engine operating in a conventional compression ignition mode, according to an aspect of the disclosure.

FIG. 5 shows a schematic view of an IC engine operating in an HCCI mode, according to an aspect of the disclosure.

FIG. 6 shows a schematic view of an IC engine operating in a piloted HCCI mode, according to an aspect of the disclosure.

FIG. 7 shows a flowchart of a method for operating an IC engine, according to an aspect of the disclosure.

### DETAILED DESCRIPTION

Aspects of the disclosure will now be described in detail with reference to the drawings, wherein like reference numbers refer to like elements throughout, unless specified otherwise.

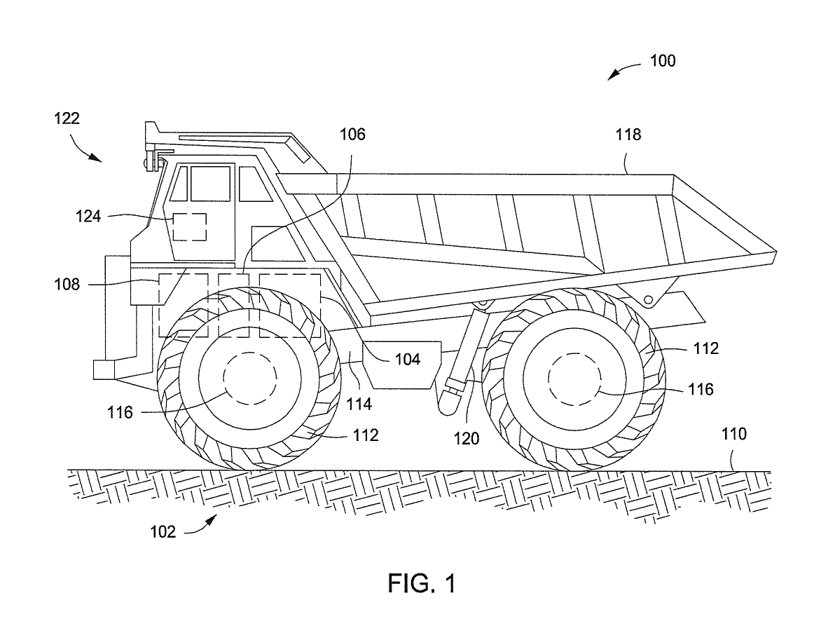

FIG. 1 shows a side view of a machine 100, according to an aspect of the disclosure. The machine 100 is powered by a hybrid powertrain 102, which includes an internal combustion (IC) engine 104, a generator 106, and an energy storage device 108. The IC engine 104 maybe a reciprocating internal combustion engine, such as a compression ignition engine or a spark ignition engine, for example, or a rotating internal combustion engine, such as a gas turbine, for example. The energy storage device 108 may include electric batteries, a capacitor, a flywheel, a resilient fluid accumulator, combinations thereof, or any other energy storage device known in the art. The generator 106 may include an electric generator, a hydraulic pump, a pneumatic compressor, combinations thereof, or any other device known in the art for converting mechanical shaft power in to another type of power.

The machine 100 may be propelled over a work surface 110 by wheels 112 coupled to a chassis 114. The wheels 112 are driven by motors 116 operably coupled thereto. It will be appreciated that the machine 100 could also be propelled by tracks (not shown), combinations of wheels 112 and tracks, or any other surface propulsion device known in the art. Alternatively, the machine 100 could be a stationary machine, and therefore not include a propulsion device.

The machine 100 may also include a work implement 118 driven by an actuator 120. The work implement 118 could be a dump bed, a shovel, a drill, a fork lift, a feller buncher, a conveyor, or any other implement known in the art for performing work on a load. The actuator 120 may be a hydraulic actuator, such as a linear hydraulic actuator or a hydraulic motor, an electric motor, a pneumatic actuator, or any other actuator known in the art.

The machine may include a cab 122 configured to accommodate an operator, and have a user interface 124 including using input devices for asserting control over the machine 100. The user interface 124 may include pedals, wheels, joysticks, buttons, touch screens, combinations thereof, or any other user input device known in the art. Alternatively or additionally, the user interface 124 may include provisions for receiving control inputs remotely from the cab 122, including wired or wireless telemetry, for example.

The machine can be an “over-the-road” vehicle such as a truck used in transportation or may be any other type of machine that performs some type of operation associated with an industry such as mining, construction, farming, transportation, or any other industry known in the art. For example, the machine may be an off-highway truck, earth-moving machine, such as a wheel loader, excavator, dump truck, backhoe, motor grader, material handler, or the like. The term “machine” can also refer to stationary equipment like a generator that is driven by an internal combustion engine to generate electricity. The specific machine 100 illustrated in FIG. 1 is a dump truck having a dump bed 118 actuated by a linear hydraulic cylinder 120.

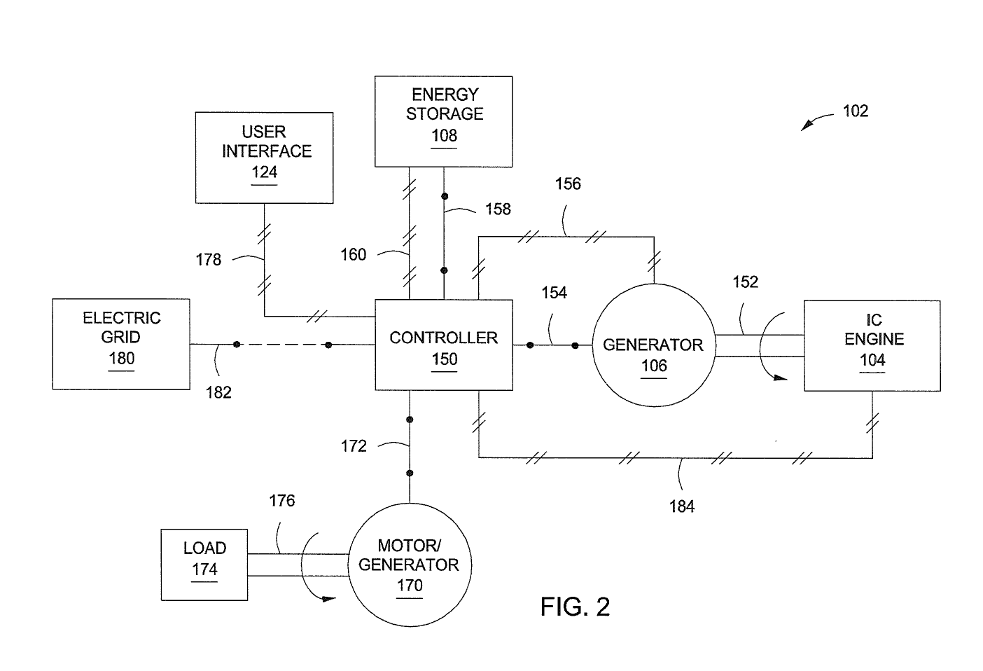

FIG. 2 shows a schematic view of a hybrid powertrain 102, according to an aspect of the disclosure. The hybrid powertrain 102 includes an IC engine 104, a generator 106, an energy storage device 108, and a controller 150. The IC engine 104 is operably coupled to the generator 106 via a shaft 152 for transmitting mechanical power therebetween. According to an aspect of the disclosure the generator 106 is a motor/generator capable of either delivering shaft power to the IC engine 104, for example, to start the IC engine 104, or receiving shaft power output from the IC engine 104 for conversion into electrical power. Alternatively or additionally, the IC engine 104 may have a dedicated starter motor (not shown) for starting the IC engine 104.

The generator 106 is electrically coupled to the controller 150 via an electrical connection 154 for transmitting electric power therebetween. Accordingly, the generator 106 may deliver electric power to the controller 150 or receive electric power from the controller 150 via the electrical connection 154. It will be appreciated that the generator 106 may simultaneously receive electrical power from the controller 150 for excitation of a magnetic field therein and transmit electric power to the controller 150. The generator 106 may also be coupled to the controller 150 by a data connection 156 for receiving sensor signals from the generator 106, adjusting operating parameters such as magnetic field strength, for example, combinations thereof, or communicating any other data known in the art to be relevant to operation of the generator 106.

According to an aspect of the disclosure, the energy storage device 108 includes an electric battery that is electrically coupled to the controller 150 via an electrical connection 158 for transmitting electric power therebetween. Accordingly, the energy storage device 108 may deliver electric power to the controller 150 or receive electric power from the controller 150 via the electrical connection 158. The energy storage device 108 may also be coupled to the controller 150 by a data connection 160 for receiving sensor signals from the energy storage device 108, such as sensor signals indicative of a state of charge of the electric battery, a temperature of the electric battery, combinations thereof, or any other data known in the art to be relevant to operation of the energy storage device 108.

The hybrid powertrain 102 includes at least one actuator 170 that is electrically coupled to the controller 150 via an electrical connection 172 for transmitting electric power therebetween. Accordingly, the controller 150 may deliver electric power to the actuator 170 or the controller 150 may receive electric power from the actuator 170 via the electrical connection 172. According to an aspect of the disclosure, the actuator 170 is an electric motor/generator.

The actuator 170 is coupled to a load 174 via a shaft 176. According to an aspect of the disclosure, the load 174 is a wheel 112 for propelling a machine 100 over a work surface 110, and the shaft 176 is a rotating shaft. According to another aspect of the disclosure, the load 174 is a work implement 118 of a machine 100, and the shaft 176 may rotate or translate relative to the actuator 170. According to another aspect of the disclosure, the load 174 is a hydraulic pump of a machine 100, and the shaft 176 may rotate or translate relative to actuator 170. Although FIG. 2 shows only one actuator 170, it will be appreciated that the hybrid powertrain 102 may include any number of actuators to suit a particular design or purpose.

The shaft 176 may transmit power from the actuator 170 to the load 174 to perform work on the load 174. However, it will be appreciated that the shaft 176 may also transmit power from the load 174 to the actuator 170 to perform work on the actuator, such as, for example, during regenerative braking of a wheel 112 using the actuator 170, lowering a load 174 in a gravity direction using the actuator 170, decelerating an inertia of a work implement load 174 using the actuator 170, or any other regenerative processes known in the art. When the actuator 170 is a motor/generator, for example, the actuator may convert a power input from the shaft 176 into electrical power delivered to the controller 150 for either storage in the energy storage device 108 or consumption in another actuator.

The controller 150 may be electrically coupled to an electric grid 180 via an electrical connection 182 for transmitting electrical power therebetween. According to an aspect of the disclosure, the electrical connection 182 may be intermittent at the discretion of a user of the hybrid powertrain 102.

The controller 150 may be in data communication with the user interface 124 via a data connection 178 for receiving control inputs from a user of the hybrid powertrain 102. Further, the controller 150 may be in data communication with the IC engine 104 via a data connection 184 for receiving sensor signals from the IC engine 104, delivering control inputs to the IC engine 104, combinations thereof, or for transmitting any data known in the art to be relevant to operation of the IC engine 104. It will be appreciated that the data connections 156, 160, 178, and 184 may include wired connections, wireless connections, combinations thereof, or any other data communication means known in the art.

The controller 150 may be any purpose-built processor for effecting control of the hybrid powertrain 102. It will be appreciated that the controller 150 may be embodied in a single housing, or a plurality of housings distributed throughout the hybrid powertrain 102. Further, the controller 150 may include power electronics, preprogrammed logic circuits, data processing circuits, volatile memory, non-volatile memory, software, firmware, combinations thereof, or any other controller structures known in the art.

The controller 150 may be configured to transfer electric power among the several components of the hybrid powertrain 102. During a recharging mode, the controller 150 may direct electric power from the electric grid 180, the actuator 170, the generator 106, or combinations thereof to the energy storage device 108 for storage of energy therein. Alternatively or additionally, the controller 150 may direct electric power from the electric grid 180 to the at least one actuator 170 for performing work on a load 174, or to the generator 106 to provide shaft power for starting the IC engine 104.

According to another aspect of the disclosure, the controller 150 is configured to direct electric power output from the generator 106 to the energy storage device 108, the at least one actuator 170, or both. According to another aspect of the disclosure, the controller may be configured to turn off the IC engine 104 and direct electrical energy from the energy storage device 108 to the at least one actuator 170, to the generator 106 for restarting the IC engine, or combinations thereof.

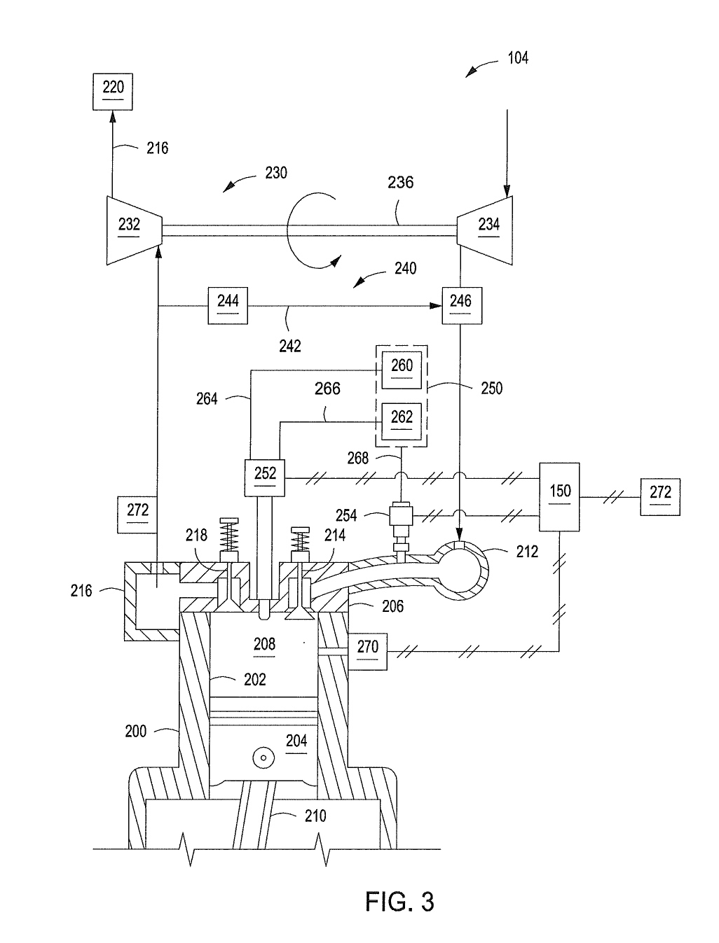

FIG. 3 shows a schematic view of an IC engine 104, according to an aspect of the disclosure. The IC engine 104 includes a block 200 defining at least one cylinder bore 202 therein, at least one piston 204 disposed in sliding engagement with the cylinder bore 202, and a head 206 disposed on the block 200. The cylinder bore 202, the piston 204, and the head 206 define a combustion chamber 208. A volume of the combustion chamber 208 may vary with the location of the piston 204 relative to the head 206, such that the volume of the combustion chamber 208 is at a maximum when the piston 204 is located at Bottom Dead Center (BDC) of its stroke, and the volume of the combustion chamber 208 is at a minimum when the piston 204 is located at Top Dead Center (TDC) of its stroke.

The IC engine 104 may operate according to a four-stroke cycle, including an intake stroke (TDC to BDC), a compression stroke (BDC to TDC), an expansion stroke (TDC to BDC), and an exhaust stroke (BDC to TDC). Alternatively, the IC engine 104 may operate according to a two-stroke cycle, including a compression/exhaust stroke (BDC to TDC) and an expansion/exhaust/intake stroke (TDC to BDC).

The piston 204 is pivotally connected to a crankshaft (not shown) via a connecting rod 210 for transmitting mechanical power therebetween. Although only one piston 204 and cylinder bore 202 are shown in FIG. 3, it will be appreciated that the IC engine 104 may be configured to include any number of pistons and cylinder bores to suit a particular design or application.

The IC engine 104 receives a flow of oxidizer from an intake duct 212. One or more intake valves 214 effect selective fluid communication between the intake duct 212 and the combustion chamber 208. The IC engine 104 discharges a flow of exhaust to an exhaust duct 216. One or more exhaust valves 218 effect selective fluid communication between the combustion chamber 208 and the exhaust duct 216. The intake valves 214 and the exhaust valves 218 may be actuated by a cam/push-rod/rocker arm assembly (not shown), a solenoid actuator, a hydraulic actuator, or by any other cylinder valve actuator known in the art to open or close intake and exhaust valves.

The exhaust duct 216 may incorporate one or more exhaust aftertreatment modules 220 for trapping exhaust constituents, converting an exhaust constituent from one composition to another composition, or both. The one or more exhaust aftertreatment modules 220 may include a particulate filter, a nitrogen oxides (NOx) conversion module, an oxidation catalyst, combinations thereof, or any other exhaust aftertreatment device known in the art. According to an aspect of the disclosure, the IC engine 104 does not include a particulate filter.

According to an aspect of the disclosure, the IC engine 104 includes a turbocharger 230 having a turbine 232 operably coupled to a compressor 234 via a shaft 236. The turbine 232 receives a flow of exhaust gas via the exhaust duct 216 and extracts mechanical work from the exhaust gas by expansion of the exhaust gas therethrough. The mechanical work extracted from the turbine 232 from the flow of exhaust gas is transmitted to the compressor 234 via the shaft 236. The compressor 234 receives a flow of oxidizer, such as, for example, ambient air, and performs work on the flow of oxidizer by compression thereof. The flow of compressed oxidizer is discharged from the compressor 234 into the intake duct 212.

Additionally, the IC engine 104 may include an Exhaust Gas Recirculation (EGR) loop 240 for conveying exhaust gas into the oxidizer flow. The EGR loop 240 may include an EGR conduit 242 in fluid communication with the exhaust duct 216 upstream of the turbine 232, and in fluid communication with the intake duct 212 downstream of the compressor 234, effecting a so-called “high-pressure EGR loop.” The EGR conduit 242 may incorporate an EGR conditioning module 244 that effects cooling, filtering, or throttling of exhaust gases flowing therethrough, combinations thereof, or any other exhaust gas processing known to benefit the operation of the EGR loop 240. The EGR conduit 242 may couple with the intake duct 212 at a mixing device 246 configured to effect mixing between the recirculated exhaust gas and the flow of oxidizer.

The IC engine 104 receives combustible fuel from a fuel supply system 250. The fuel supply system 250 may include fuel storage, compressors, pumps, valves, regulators, instrumentation, or any other elements known in the art to be useful for supplying a flow of fuel. The IC engine 104 includes a direct fuel injector 252 disposed in direct fluid communication with the combustion chamber 208, a port fuel injector 254 disposed in the intake duct 212 upstream of the intake valve 214, combinations thereof, or any other fuel injector arrangement known in the art. The direct fuel injector 252 and the port fuel injector 254 may each be operatively coupled to the controller 150 for control thereof.

The fuel supply system 250 may include a first fuel supply 260, a second fuel supply 262, or both. The direct fuel injector 252 may be in fluid communication with the first fuel supply 260 via a first fuel conduit 264, the second fuel supply 262 via a second fuel conduit 266, or both. The port fuel injector may be in fluid communication with the second fuel supply 262 via a third fuel conduit 268.

According to an aspect of the disclosure, the first fuel supply 260 is a liquid fuel supply that delivers a liquid fuel to the combustion chamber 208. The liquid fuel may include distillate diesel, biodiesel, dimethyl ether, ethanol, methanol, seed oils, liquefied natural gas (LNG), liquefied petroleum gas (LPG), Fischer-Tropsch derived fuel, combinations thereof, or any other combustible liquid known in the art to have a sufficiently high octane value and a sufficiently low cetane value to enable compression ignition in a reciprocating IC engine. According to another aspect of the disclosure, the first fuel supply 260 is a distillate diesel fuel supply.

According to an aspect of the disclosure, the second fuel supply 262 is a gaseous fuel supply that delivers a gaseous fuel to the combustion chamber 208. The gaseous fuel may include natural gas, methane, propane, hydrogen, biogas, syngas, combinations thereof, or any other combustible gas known in the art. According to another aspect of the disclosure, the gaseous fuel is natural gas. According to yet another aspect of the disclosure, the gaseous fuel is a combustible gas comprising at least 50% methane by mole.

The direct fuel injector 252 is configured to effect selective fluid communication between the fuel supply system 250 and the combustion chamber 208. For example, the direct fuel injector may assume any one of the following four fluid configurations. According to a first configuration, the direct fuel injector 252 blocks fluid communication between both the first fuel supply 260 and the second fuel supply 262, and the combustion chamber 208. According to a second configuration, the direct fuel injector 252 blocks fluid communication between the first fuel supply 260 and the combustion chamber 208 and effects fluid communication between the second fuel supply 262 and the combustion chamber 208. According to a third configuration, the direct fuel injector 252 effects fluid communication between the first fuel supply 260 and the combustion chamber 208 and blocks fluid communication between the second fuel supply 262 and the combustion chamber 208. According to a fourth configuration, the direct fuel injector 252 effects fluid communication between both the first fuel supply 260 and the second fuel supply, and the combustion chamber 208.

The direct fuel injector 252 may include an actuator configured to change the fluid configuration of the direct fuel injector 252 under the control of the controller 150. The actuator for the direct fuel injector 252 may include a solenoid actuator, a hydraulic actuator, a pneumatic actuator, a mechanical actuator, such as, for example a cam actuator, combinations thereof, or any other fuel injector actuator known in the art.

Similarly, the port fuel injector 254 is configured to effect selective fluid communication between the fuel supply system 250 and the combustion chamber 208. For example, the port fuel injector 254 may assume one of the two following fluid configurations. According to a first configuration, the port fuel injector 254 blocks fluid communication between the second fuel supply 262 and the intake duct 212. According to a second configuration, the port fuel injector 254 effects fluid communication between the second fuel supply 262 and the intake duct.

The port fuel injector 254 may include an actuator configured to change the fluid configuration of the port fuel injector 254 under the control of the controller 150. The actuator for the port fuel injector 254 may include a solenoid actuator, a hydraulic actuator, a pneumatic actuator, a mechanical actuator, such as, for example a cam actuator, combinations thereof, or any other fuel injector actuator known in the art.

### INDUSTRIAL APPLICABILITY

The present disclosure is generally applicable to internal combustion/electric hybrid powertrain systems and methods of operating the same.

Referring to FIG. 3, the controller 150 is configured to operate the IC engine 104 in different operating modes. According to an aspect of the disclosure, the controller 150 is configured to operate the IC engine 104 in a conventional compression ignition mode, a homogeneous charge compression ignition (HCCI) mode, and a piloted HCCI mode.

The conventional compression ignition mode is characterized by most, if not all, of the fuel being injected relatively late in the compression stroke, when the temperature and pressure in the combustion chamber are sufficient to autoignite mixtures of the fuel and oxidizer. The autoignition delay times are relatively short, and in turn, the start of combustion is largely determined by the fuel injection timing. According to an aspect of the disclosure, the conventional compression ignition mode is a diesel operating mode.

As a result of the short residence time of the fuel and oxidizer between the fuel injection and the start of combustion, the combustion process may proceed in a largely mixing-limited fashion, resulting in propagation of a substantially non-premixed or diffusion-type flame through the fuel-oxidizer mixture in the combustion chamber. In turn, much of the fuel may burn at a near-stoichiometric mixture at a boundary between fuel rich regions and adjacent oxidizer, resulting in high flame temperatures and relatively rapid formation of nitrogen oxides (NOx) and particulate matter. According to an aspect of the disclosure for the conventional compression ignition mode, most, if not all, of the fuel is injected between about 30 degrees before TDC of the compression stroke and about 20 degrees after TDC of the compression stroke.

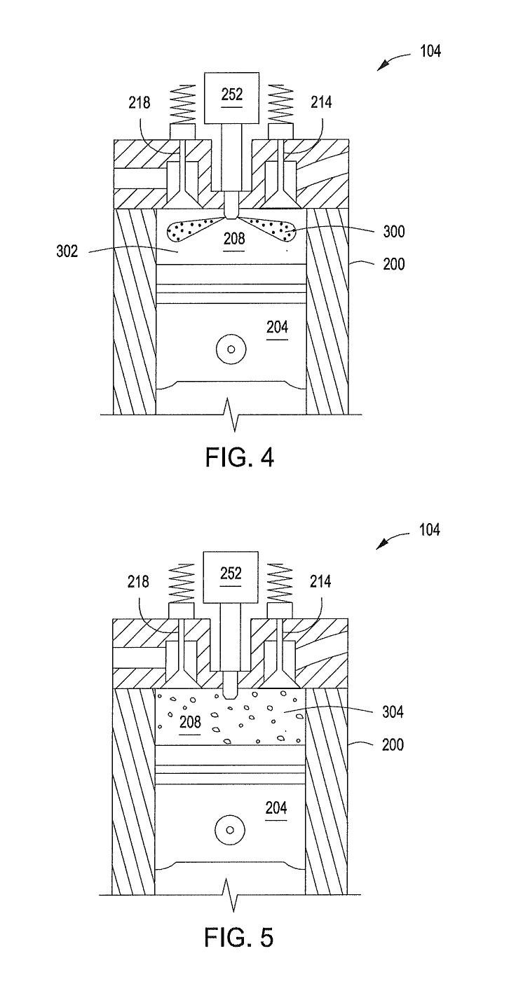

For example, FIG. 4 shows a schematic cross sectional view of an IC engine 104 operating in a conventional compression ignition mode, according to an aspect of the disclosure. In FIG. 4, the piston 204 is near TDC of the compression stroke, which may include piston locations before or after TDC of the compression stroke, pressure and temperature in the combustion chamber 208 are sufficient to effect autoignition, and the exhaust valve 218 and intake valve 214 are in closed positions. The direct fuel injector 252 injects a portion of high octane and/or low cetane fuel 300 into a mass of compressed oxidizer 302. After an ignition delay time, corresponding to factors including pressure and temperature in the combustion chamber 208, chemical composition of the oxidizer, and chemical composition of the injected fuel 300, the portion of fuel 300 burns in the mass of compressed oxidizer 302 in a largely mixing-limited fashion.

The HCCI mode is characterized by most, if not all, of the fuel being injected relatively early in the compression stroke, or even during the preceding intake stroke, when the temperature and pressure in the combustion chamber are insufficient to autoignite mixtures of the fuel and oxidizer. Accordingly, the fuel and oxidizer enjoy a relatively long time duration, and charge motion caused by the motion of the piston in the cylinder bore, to thoroughly evaporate and form a lean, substantially homogeneous mixture of fuel and oxidizer. According to an aspect of the disclosure, a lean and substantially homogeneous mixture of fuel and oxidizer is devoid of mixture portions having a rich stoichiometry at the start of combustion.

The start of combustion during the HCCI mode is then determined by when the temperature and pressure in the combustion chamber reach conditions sufficient to support autoignition of the lean fuel-oxidizer mixture. As a result of the premixed nature of the fuel and oxidizer and the autoignition conditions present at the start of combustion, the combustion process proceeds rapidly over the volume of the combustion chamber with little or no discernable flame propagation. In turn, much of the fuel burns at a lean equivalence ratio, which results in low flame temperatures and slow formation of NOx and particulates. According to an aspect of the disclosure for the HCCI mode, most, if not all, of the fuel is introduced into the combustion chamber before about 30 degrees before TDC. During the HCCI mode fuel may be introduced into the combustion chamber 208 via the direct fuel injector 252, the port fuel injector 254, or combinations thereof.

For example, FIG. 5 shows a schematic cross sectional view of an IC engine 104 operating in an HCCI mode, according to an aspect of the disclosure. In FIG. 5, the piston 204 is before TDC of the compression stroke, pressure and temperature in the combustion chamber 208 are still insufficient to effect autoignition of a lean fuel-oxidizer mixture, and the exhaust valve 218 and intake valve 214 are in closed positions. Prior to the timing shown in FIG. 5, a portion of fuel was introduced into the combustion chamber 208 by the direct fuel injector 252, the port fuel injector 254, or both, and the portion of fuel mixed with an oxidizer to form a substantially homogeneous fuel-oxidizer mixture 304 in the combustion chamber 208. The mixture 304 ignites after further compression, thereby increasing both the pressure and temperature of the mixture 304, and the mixture 304 burns in a largely premixed mode.

It will be appreciated that the stoichiometry of the fuel-oxidizer mixture 304 may be varied with factors including, but not limited to, the load of the IC engine 104 across a plurality of discreet and preselected HCCI operating conditions.

The piloted HCCI mode is characterized by most of the fuel being injected relatively early in the compression stroke, similar to the HCCI mode, but then ignition timing is largely determined by a later and relatively smaller pilot injection of fuel near TDC of the compression stroke. Although the pressure and temperature in the combustion chamber may not be sufficient to autoignite the lean homogeneous mixture of fuel and oxidizer, the richer pilot injection autoignites after a short ignition delay time, thereby providing an ignition source to propagate a flame through the lean premixture of fuel and oxidizer. In turn, most of the fuel burns at a lean equivalence ratio, and therefore a low flame temperature and corresponding low formation rates of NOx and particulate matter, while the pilot injection improves control over the start of combustion.

According to an aspect of the disclosure for the piloted HCCI mode, most of the fuel is introduced into the combustion chamber before about 30 degrees before TDC. According to another aspect of the disclosure for the piloted HCCI mode, over 90% of the fuel, by heating value, is introduced into the combustion chamber before about 30 degrees before TDC, and less than about 10% of the remaining fuel is injected via a direct pilot injection after about 30 degrees before TDC. During the HCCI mode, most of the fuel may be introduced into the combustion chamber 208 via the direct fuel injector 252, the port fuel injector 254, or combinations thereof.

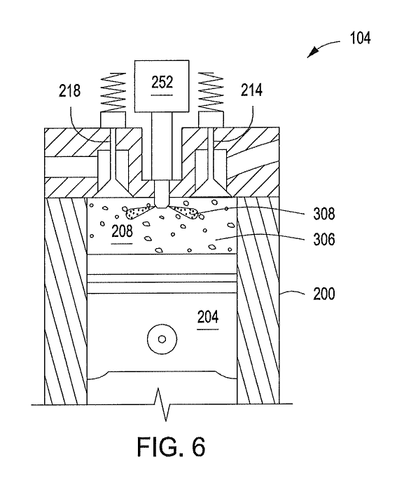

For example, FIG. 6 shows a schematic cross sectional view of an IC engine 104 operating in a piloted HCCI mode, according to an aspect of the disclosure. In FIG. 6, the piston 204 is near TDC of the compression stroke, which may include piston locations before or after TDC of the compression stroke; pressure and temperature in the combustion chamber 208 are still insufficient to effect autoignition of a lean fuel-oxidizer mixture; and the exhaust valve 218 and intake valve 214 are in closed positions. Prior to the timing shown in FIG. 5, a portion of fuel was introduced into the combustion chamber 208 by the direct fuel injector 252, the port fuel injector 254, or both, and the portion of fuel mixed with an oxidizer to form a substantially homogeneous lean fuel-oxidizer mixture 306 in the combustion chamber 208. A second portion of fuel having a relatively high octane number and/or low cetane number 308 is injected into the combustion chamber 208 as a pilot fuel injection. Although the pressure and temperature in the combustion chamber 208 are insufficient to effect autoignition of the fuel-oxidizer mixture 306, conditions are sufficient to effect autoignition of the second portion of fuel 308 near the richer boundary with the lean fuel-oxidizer mixture 306. In turn, the second portion of fuel 308 proceeds to burn in a largely mixing-limited combustion mode, which acts as an ignition source to ignite the fuel-oxidizer mixture 306 in a largely premixed combustion mode.

During the HCCI mode, most, if not all of the fuel may be gaseous fuel from the second fuel supply 262. During the piloted HCCI mode, most of the fuel may be gaseous fuel from the second fuel supply 262, while the pilot injection is a high octane and/or low cetane fuel supplied by the first fuel supply 260.

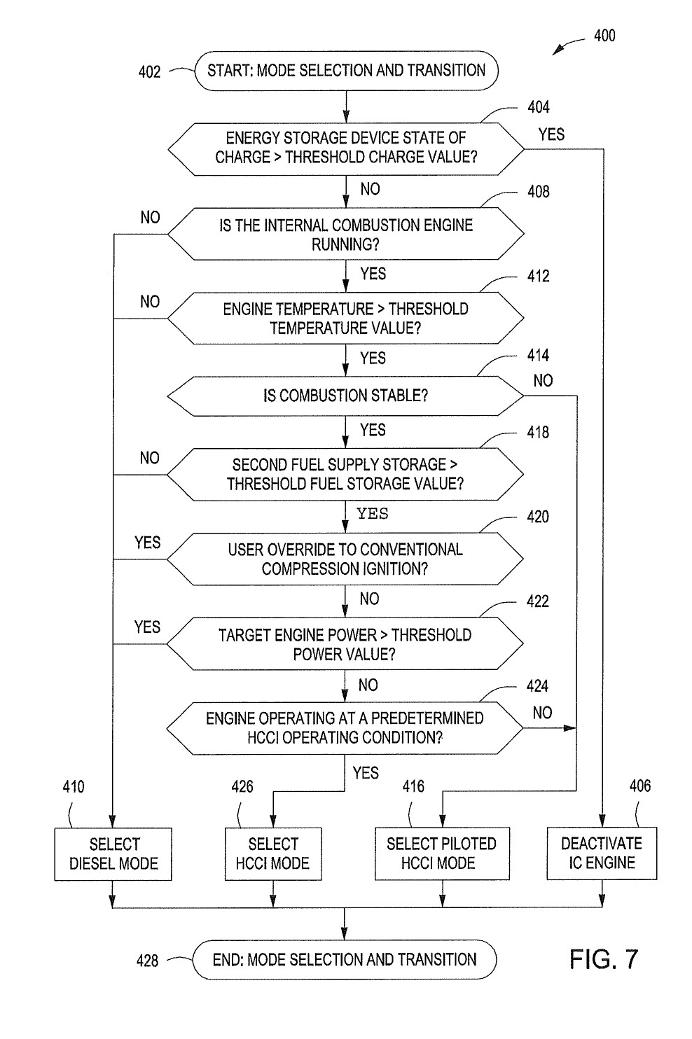

FIG. 7 shows a flowchart of a method 400 for operating an IC engine 104, according to an aspect of the disclosure. In particular, FIG. 7 illustrates a method 400 for changing an operation mode of an IC engine 104 beginning at the starting Step 402, where the method 400 selects an operation mode and, if necessary, changes an operating mode of the IC engine 104 to assume the selected operating mode.

In Step 404 a state of charge of the energy storage device 108 is assessed, and the state of charge is compared to a threshold charge value. When the energy storage device 108 is an electric battery, for example, the state of charge of the electric battery may be assessed by measuring a voltage across terminals of the battery, measuring a total amount of energy stored in the battery, measuring a temperature of the battery, combinations thereof, or any other parameter known in the art to be indicative of a state of charge of a battery. When the state of charge of the energy storage device 108 is above the threshold charge value, then further charging of the energy storage device 108 may not be desired, and in turn, the method 400 proceeds to Step 406 where the IC engine 104 is deactivated and any operations of the hybrid powertrain 102 are powered exclusively by the energy storage device 108.

When the state of charge of the energy storage device 108 is less than or equal to the threshold charge value, then further charging of the energy storage device 108 may be desired, and in turn, the method 400 proceeds to Step 408, where the method 400 determines whether the IC engine 104 is running If the IC engine 104 is not running, then the method 400 proceeds to Step 410 where the IC engine 104 operating mode is set to the conventional compression ignition mode. According to an aspect of the disclosure, the conventional compression ignition mode is selected as the mode for starting the IC engine 104.

If the IC engine 104 is running, then the method 400 proceeds to Step 412, where a temperature of the engine is assessed and compared to a threshold temperature value. The temperature of the engine may be assessed by measuring a temperature of the block 200, a temperature of a coolant flowing through the block 200, a temperature of a lubricant flowing through the IC engine 104, a viscosity of a lubricant flowing through the IC engine 104, combinations thereof, or any other value indicative of the temperature of the IC engine 104 known in the art. According to an aspect of the disclosure, the temperature of the engine is assessed by measuring a coolant temperature and the threshold value is about 176 degrees Fahrenheit (80 degrees Celsius).

If the IC engine 104 temperature is less than or equal to the threshold value, then the method 400 proceeds to Step 410, where conventional compression ignition is selected as the IC engine 104 operating mode. If the IC engine 104 temperature is greater than the threshold temperature value, then the method 400 proceeds to Step 414, where the method 400 determines if the combustion is stable.

The method 400 may evaluate whether the combustion is stable by measuring and analyzing a time history of combustion chamber 208 pressure, a time history of exhaust temperature, combinations thereof, or any other measurement and/or analysis known in the art to be indicative of combustion stability, and comparing resulting indicia of stability to a threshold stability value. For example, pressure in the combustion chamber may be measured by an in-cylinder pressure transducer 270 (see FIG. 3) and communicated to the controller 150. According to another aspect of the disclosure, temperature of the exhaust gas may be measured by a temperature sensor 272 and communicated to the controller 150. The controller 150 may perform analysis of the in-cylinder pressure transducer 270 signal, the exhaust temperature sensor 272 sensor, or both, including time domain analysis of averages, standard deviations, covariances, or combinations thereof; or frequency domain analysis to determine content in particular frequency bands; or both time domain analysis and frequency domain analysis.

When comparison of the stability indicia to the threshold stability value indicates unstable combustion, then the method 400 proceeds to Step 416, where piloted HCCI is selected as the operating mode for the IC engine 104. Else, the method 400 proceeds to Step 418 where the amount of fuel stored in the second fuel supply 262 is assessed and compared to a threshold fuel storage value. The amount of fuel stored in the second fuel supply 262 may be evaluated by measuring a pressure of a storage tank, a fluid level of storage tank, subtracting an integrated outflow from the second fuel supply 262 from a known starting value, combinations thereof, or any other method known in the art for assessing an amount of stored fuel. According to an aspect of the disclosure, the amount of fuel stored in the second fuel supply 262 is an amount of natural gas stored.

The threshold fuel storage value may be a function of an amount of fuel stored in the first fuel supply 260. For example the threshold fuel storage value may be an amount of fuel stored in the first fuel supply 260 that is adjusted by a minimum first fuel supply value. It will be appreciated that the amounts of fuel stored in the first fuel supply 260 and the second fuel supply 262 may be assessed on a mass basis, a molar basis, a heating value basis, or combinations thereof.

When the amount of fuel in the second fuel supply 262 is less than or equal to the threshold fuel storage value, then the method 400 proceeds to Step 410, where the operating mode for the IC engine 104 is set to conventional compression ignition. If the amount of fuel in the second fuel supply 262 is greater than the threshold fuel storage value, then the method 400 proceeds to Step 420, where a user operating mode override is considered.

If the user has input a command to operate the IC engine 104 in the conventional compression ignition mode, for example, through an input to the controller 150 through the user interface 124, then the method 400 proceeds to Step 410, where conventional compression ignition is selected as the operating mode for the IC engine 104. If the user has not input a command to operate the IC engine 104 in the conventional compression ignition mode, then the method 400 proceeds to Step 422, where a target power of the IC engine 104 is compared to a threshold power value. The target power of the IC engine could be an engine power demand value generated by the controller 150 in response to operator inputs to the controller 150, power needed to accomplish anticipated functions by the hybrid powertrain 102, combinations thereof, or any other operating parameter known in the art to be relevant to setting a power output of the IC engine 104. According to an aspect of the disclosure, the threshold power value is 80% of a maximum engine power rating.

When the target IC engine 104 power is greater than the threshold power value, the method proceeds to Step 410, where the IC engine operating mode is set to the conventional compression ignition mode. If the target IC engine 104 power is less than or equal to the threshold power value, the method 400 proceeds to Step 424, where a determination is made whether the IC engine 104 is operating at a preselected HCCI operating condition.

The controller 150 may include definitions for one or more preset HCCI operating conditions. According to an aspect of the disclosure, the controller 150 includes definitions for two or more preset HCCI operating conditions. These preset HCCI operating conditions may be defined through laboratory testing, field testing, physics-based models, empirical models, fuzzy logic neural network analysis, combinations thereof, or any other analysis technique for defining an engine operating point. The preselected HCCI operating points may reference a power of the IC engine, such as, for example, by referencing paired values of engine speed and engine torque. According to another aspect of the disclosure, the preselected HCCI operating points may reference an array of engine torque values along a line of constant engine speed.

If the IC engine 104 is not operating at a preset HCCI operating point, then the method 400 proceeds to Step 416, where the IC engine 104 operating mode is set to piloted HCCI. Else, if the IC engine is operating at a preset HCCI operating point, then the method 400 proceeds to Step 426, where the operating mode of the IC engine 104 is set to the HCCI operating mode. The method 400 ends at Step 428, where the method may change the operating state of the IC engine 104 to a selected operating state, repeat the mode selection method 400, proceed to another engine operation algorithm, or combinations thereof.

It will be appreciated that any of the methods or functions described herein may be performed by or controlled by the controller 150. Further, any of the methods or functions described herein may be embodied in a computer-readable non-transitory medium for causing the controller 150 to perform the methods or functions described herein. Such computer-readable non-transitory media may include magnetic disks, optical discs, solid state disk drives, combinations thereof, or any other computer-readable non-transitory medium known in the art. Moreover, it will be appreciated that the methods and functions described herein may be incorporated into larger control schemes for an engine, a hybrid powertrain, a machine, or combinations thereof, including other methods and functions not described herein.

The lean premixed HCCI combustion mode may offer advantages to improving the efficiency of a hybrid powertrain 102, reducing regulated emissions of a hybrid power train 102, or both. Aspects of the present disclosure further address some of the control challenges associated with HCCI combustion by providing methods to change operating modes of the IC engine. For example, the present disclosure provides for starting the IC engine 104, cold operation of the IC engine 104, and high-power operation of the IC engine 104 in a conventional compression ignition mode where control of HCCI operation poses challenges. Further aspects of the disclosure provide for operating the IC engine 104 in a piloted HCCI mode when transitioning from a preselected HCCI mode to another preselected HCCI mode, when combustion instability is detected, or both, thereby improving the performance of the hybrid powertrain 102. Other optional aspects of the present disclosure provide the aforementioned benefits without relying on potentially expensive and complex engine systems such as variable valve timing, variable compression ratio systems, and the like. Further, aspects of the disclosure may decrease the dependency on slower response systems, such as EGR and intake temperature control for example, to control HCCI combustion, in favor of faster time response strategies such as piloted HCCI.

Aspects of the disclosure providing a serial hybrid powertrain 102, promote the emissions and efficiency advantages of HCCI operation of the IC engine 104 by providing indirect coupling between the IC engine 104 power and that of a load 174. Indeed, the peak shaving and energy storage functions provided by the energy storage device 108 in a serial hybrid configuration enable the IC engine 104 to run at preselected and pre-tuned HCCI operating points and thereby minimize challenges associated with controlling transient operation of the IC engine 104 in an HCCI mode and challenges associated with engine calibration over a continuous power spectrum. Further aspects of the disclosure, provide a piloted HCCI operating mode to facilitate transfers between preselected HCCI operating points, damp combustion instabilities, or both.

Aspects of the disclosure also provide for fuel flexibility. For example, when the first fuel supply 260 is a diesel fuel supply and the second fuel supply 262 is a gaseous fuel supply, aspects of the disclosure provide for selection of an operating mode to best accommodate onboard fuel reserves of the diesel fuel supply and the gaseous fuel supply.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Unless specified otherwise, the term “substantially” is used herein to mean “considerable in extent” or “largely but not necessarily wholly that which is specified.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A hybrid powertrain system, comprising:
an internal combustion engine having a piston configured to reciprocate within a cylindrical bore, the piston and the cylindrical bore at least partly defining a combustion chamber;
an electric generator operatively coupled to the internal combustion engine;
a fuel injection system in fluid communication with at least one fuel source and the combustion chamber; and
a controller operatively coupled to the fuel injection system, wherein the controller is configured to:
effect a first mixture including a first portion of fuel and a first portion of oxidizer while the internal combustion engine operates at a first predetermined load, the first mixture being lean of stoichiometric and being substantially homogeneous throughout the combustion chamber at a first start of combustion time,
effect a second mixture including a second portion of fuel and a second portion of oxidizer while the internal combustion engine operates at a second predetermined load, the second mixture being lean of stoichiometric and being substantially homogeneous throughout the combustion chamber at a second start of combustion time, and
effect a third mixture including a third portion of fuel and a third portion of oxidizer while the internal combustion engine transitions from the first predetermined load to the second predetermined load, the third mixture including a fuel-rich region being rich of stoichiometric at a third start of combustion time.

2. The system of claim 1, further comprising at least one motor electrically coupled to the electric generator and operatively coupled to a load, the load being coupled to the internal combustion engine via a series hybrid arrangement through the electric generator and an energy storage device.

3. The system of claim 2, wherein the load is a propulsive drive wheel of a machine.

4. The system of claim 2, wherein the load is a work implement of a machine.

5. The system of claim 1, wherein the at least one fuel source includes a first fuel source and a second fuel source, and
wherein a composition of the third portion of fuel includes a first fuel supplied by the first fuel source and a second fuel supplied by the second fuel source, a composition of the first fuel being different from a composition of the second fuel.

6. The system of claim 5, wherein the second fuel is a gaseous fuel and the first fuel is a liquid fuel.

7. The system of claim 6, wherein methane composes more than half of the second fuel by mole.

8. The system of claim 6, wherein the first fuel is a liquid fuel selected from the group consisting of distillate diesel, biodiesel, dimethyl ether, and combinations thereof.

9. The system of claim 1, wherein the controller is configured to transition the internal combustion engine from the first predetermined load to the second predetermined load at a constant speed of the internal combustion engine.

10. The system of claim 1, wherein the at least one fuel source includes a first fuel source and a second fuel source, and the controller is further configured to
select the first portion of fuel and the second portion of fuel from the second fuel source when a load of the internal combustion engine is above a first threshold load value and below a second threshold load value, and
operate the internal combustion engine in a conventional direct injection compression ignition mode using a fuel from the first fuel source when the load of the internal combustion engine is below the first threshold load value or above the second threshold load value.

11. The system of claim 10, wherein the second fuel source is a gaseous fuel source and the first fuel source is a liquid fuel source.

12. The system of claim 11, wherein the first fuel source provides a liquid fuel selected from the group consisting of distillate diesel, biodiesel, dimethyl ether, and combinations thereof.

13. The system of claim 10, wherein the combustion chamber does not receive fuel from the second fuel source while operating in the conventional direct injection compression ignition mode.

14. The system of claim 2, wherein the load is free from direct mechanical coupling with a shaft of the internal combustion engine.

15. The system of claim 1, wherein the first portion of oxidizer and the second portion of oxidizer comprise air and a recirculated exhaust gas.

16. The system of claim 5, further comprising a combustion stability sensor, wherein the controller is further configured to vary relative proportions of the first fuel and the second fuel in the third mixture as a function of a signal from the combustion stability sensor.

17. The system of claim 16, wherein the combustion stability sensor is a combustion chamber pressure sensor.

18. The system of claim 16, wherein the combustion stability sensor is an exhaust temperature sensor.

19. A method for operating a hybrid powertrain, the hybrid powertrain including
an internal combustion engine having a piston configured to reciprocate within a cylindrical bore, the piston and the cylindrical bore at least partly defining a combustion chamber, and
a fuel injection system in fluid communication with at least one fuel source and the combustion chamber,
the method comprising:
operating the internal combustion engine at a first predetermined load using a first mixture including a first portion of fuel and a first portion of oxidizer, the first mixture being lean of stoichiometric and being substantially homogeneous throughout the combustion chamber at a first start of combustion time;
operating the internal combustion engine at a second predetermined load using a second mixture including a second portion of fuel and a second portion of oxidizer, the second mixture being lean of stoichiometric and being substantially homogeneous throughout the combustion chamber at a second start of combustion time; and
transitioning the internal combustion engine from the first predetermined load to the second predetermined load using a third mixture including a third portion of fuel and a third portion of oxidizer, the third mixture including a fuel-rich region being rich of stoichiometric at a third start of combustion time.

20. An article of manufacture comprising non-transitory machine-readable instructions encoded thereon for enabling a processor to perform the operations of:
effecting a first mixture in a combustion chamber of an internal combustion engine while the internal combustion engine operates at a first predetermined load, the first mixture including a first portion of fuel and a first portion of oxidizer, the first mixture being lean of stoichiometric and being substantially homogeneous throughout the combustion chamber at a first start of combustion time;
effecting a second mixture in the combustion chamber while the internal combustion engine operates at a second predetermined load, the second mixture including a second portion of fuel and a second portion of oxidizer, the second mixture being lean of stoichiometric and being substantially homogeneous throughout the combustion chamber at a second start of combustion time; and
effecting a third mixture in the combustion chamber while the internal combustion engine transitions from the first predetermined load to the second predetermined load, the third mixture including a third portion of fuel and a third portion of oxidizer, the third mixture including a fuel-rich region being rich of stoichiometric at a third start of combustion time.
